(19) United States
(12) Patent Application Publication
(10) Pub. No.: US 2005/0133598 A1
(43) Pub. Date: Jun. 23, 2005

(54) Scanning device

(75) Inventor: Yuan-Tien Kang, Hsin-Chu Science-Based Industrial Park (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MUSTEK SYSTEMS INC.

(21) Appl. No.: 10/736,559

(22) Filed: Dec. 17, 2003

(51) Int. Cl. G06K 7/10; G06K 7/14

(52) U.S. Cl. 235/454

(57) ABSTRACT

The present invention relates to a scanning device which includes a housing, a center portion, a document pathway, a document, a rotation conveying means which is placed between said center portion and said document pathway, and an image sensing unit connected to said rotation conveying means, wherein said rotation conveying means rotates, said image sensing unit rotates to conduct scanning onto said document placed at said document pathway. The present invention is able to fit a substantially narrow space of the desk-top by horizontal, vertical and declined-angle positions by the assistance of a stand.

### BACKGROUND OF THE INVENTION

1. Field of the Invention

The present invention generally relates to a scanning device which utilizes a mechanism of scanning tunnel. Particularly, a document is placed into the tunnel and later a motor rotates a scanning module to scan the document in the tunnel.

2. Background Description

Usually, a flatbed scanner is placed on a desk and connects to a personal computer. The scanning module employs a charge coupled device (CCD) as an image sensing unit. In the recent market, a Contact Image Sensor (CIS) is mostly employed as an image sensing unit. The signals of scanned images are firstly transformed from the image sensing unit to a multiplexer. The asynchronous signals are therefore modulated and offset to digital format. The digital signals are saved in a RAM buffer for further image processing. After the above steps, the mirror and lens modules as well as the light source are advanced to a next position for continuing a complete scanning.

As to the structure of a scanning device, the traditional flatbed scanner is placed on the desk. The document is placed flat on the glass of the flatbed scanner. Usually, the flatbed scanner is necessary to be placed flat and therefore needs lots space of the desk. Besides, the monitor, keyboard and others device also occupy the desk-top. The left zoom for the user is relatively small. In this case, the present invention provides a conserved scanning device with tiny desk-top need to accommodate the modern computer user's need.

### SUMMARY OF THE INVENTION

It is therefore an object of the present invention to provide a scanning device capable of being placed horizontally and vertically to fit any available space on the desk-top.

It is another object of the present invention to provide a tunnel type scanning device to scan a document with a substantial length.

It is yet an aspect of the present invention that the scanning device is able to be placed at a declined angle to conduct the scanning by the assistance of a stand.

The scanning device includes a housing, a center portion, a document pathway, a document, a rotation conveying means which is placed between said center portion and said document pathway, and an image sensing unit, connected to said rotation conveying means, wherein said rotation conveying means rotates, said image sensing unit rotates to conduct scanning onto said document placed at said document pathway.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a prior known flatbed scanner;

FIG. 2 is a three-dimension scheme diagram of the present invention;

FIG. 3 is a cross-section diagram of the present invention;

FIG. 4 is an assembly diagram of the present invention;

FIG. 5 shows the placement of the present invention.

### DETAILED DESCRIPTION OF A PREFERRED EMBODIMENT OF THE INVENTION

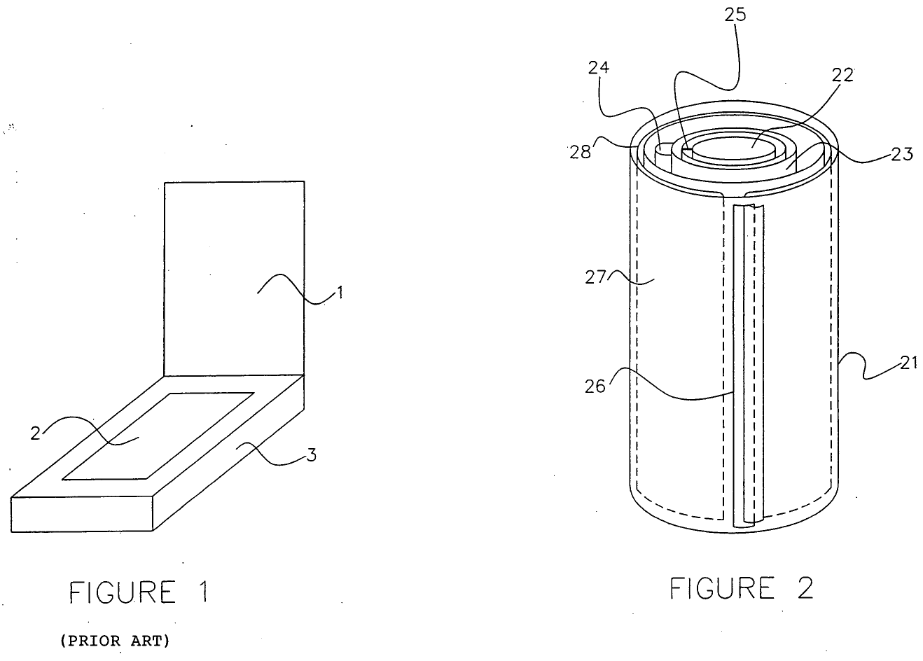

Please refer to FIG. 1, this diagram shows a traditional scanning device. In FIG. 1, the flatbed scanner 3 is placed on the desk. The document is placed on the glass 2. When the flatbed scanner is connected to a personal computer, the cover 1 is close. Usually after a button being pressed down, the flatbed scanner is able to conduct scanning.

Please refer to FIG. 2 of the present invention, there is a center portion 22 inside the tunnel housing 21. The center portion 22 is rotatable and connects to an axel of a motor which drives the center portion 22 (not shown in the figure). The center portion 22 drives an image sensing unit 24 to conduct scanning the document 27 which is inserted from the opening 26. The document pathway 28 is also inside the tunnel housing 21. A rotation conveying means 23 is placed between the tunnel housing 21 and the document pathway 28. The support 25 connects the center portion 22 and the rotation conveying means 25 for supporting purpose.

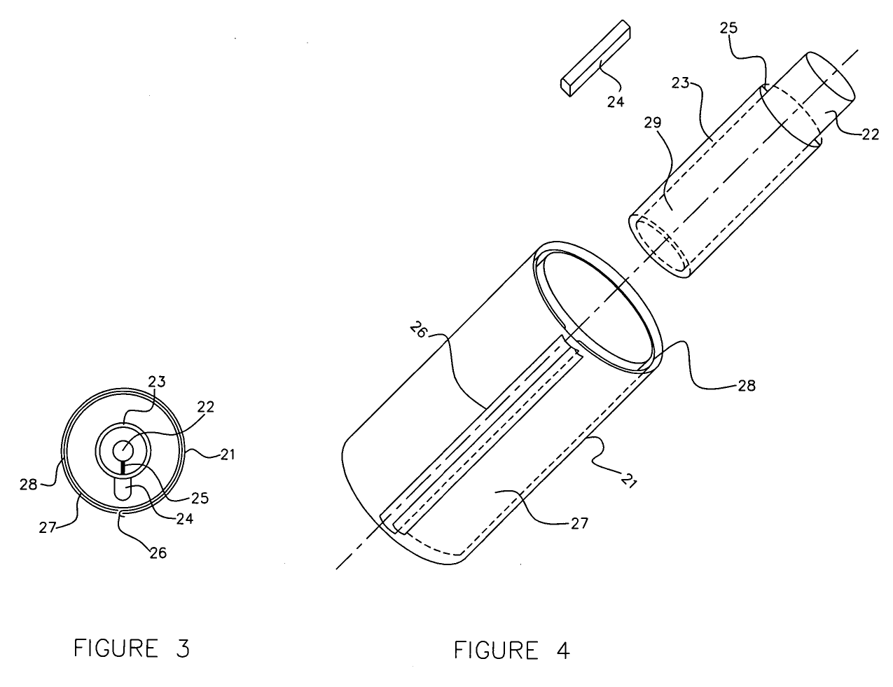

Please refer to FIG. 3, it shows the cross-section view of the present invention. It shows the center portion 22 is on the axle of the tunnel housing 21. The center portion 22 is rotatable. By the help of the support 25, the rotation conveying means 23 is therefore rotatable. In this case, the image sensing unit 24 is able to scan the document 27 in the pathway 28 by rotation.

Please refer to FIG. 4, it shows the assembly diagram of the present invention. In FIG. 4, the image sensing unit 24 is attached to the rotation conveying means 23. Therefore, when the rotation conveying means rotates, the image sensing means is able to rotate at the same direction.

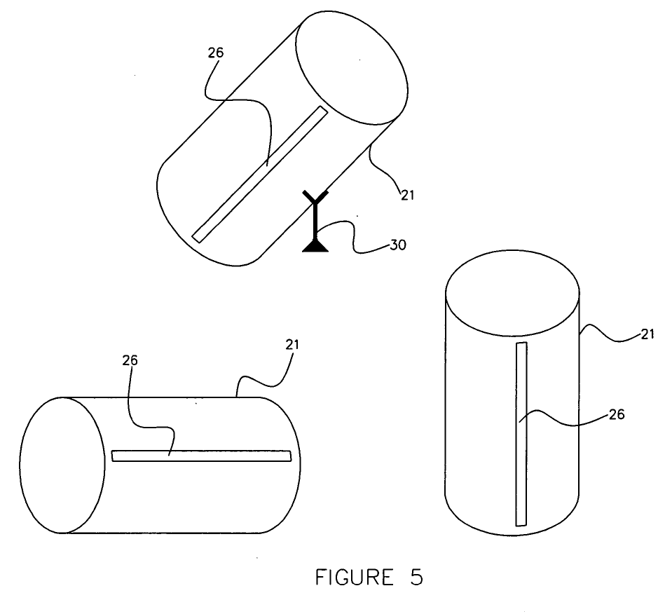

Please refer to FIG. 5, it shows the varieties of the placement of the present invention. The present invention is able to place at any available place of the desk-top at horizontal or vertical positions. By the help of stand 30, the present invention is able to be placed at a declined angle to suit a particular angle of available space of the desk-top.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. A scanning device comprising:
a housing;
a center portion inside said housing;
a document pathway, placing a document;
a rotation conveying means, placed between said center portion and said document pathway; and
an image sensing unit, connected to said rotation conveying means,
wherein said rotation conveying means rotates in a circle scanning movement said image sensing unit in order to conduct scanning onto said document placed at said document pathway.

2. The scanning device of claim 1, further comprising an opening at said housing for inserting said document into said document pathway.

3. The scanning device of claim 1, wherein said housing is a tunnel shape.

4. The scanning device of claim 1, wherein said housing is a cylinder shape.

5. The scanning device of claim 1 further comprising a support, connected said center portion and said rotation conveying means.

6. The scanning device of claim 1, wherein said image sensing unit is a charge coupled device.

7. The scanning device of claim 1, wherein said image sensing unit is a contact image sensor.

8. A scanning device comprising:
a housing with a column shape;
a center portion inside said housing;
a document pathway for inserting a document circularly though an opening;
a rotation conveying means, placed between said center portion and said document pathway; and
an image sensing unit, connected to said rotation conveying means,
wherein when said rotation conveying means rotates in a circle scanning movement said image sensing unit rotates to conduct scanning onto said document placed at said document pathway.

9. The scanning device of claim 8, further comprising a support for holding said housing at an angle.
